(19) United States
(12) Patent Application Publication
(10) Pub. No.: US 2006/0257128 A1
(43) Pub. Date: Nov. 16, 2006

(54) Image sensing apparatus

(75) Inventors: Fumiaki Ishito, Osaka (JP); Naohiko Hayashi, Osaka (JP); Tomohiro Matsumoto, Osaka (JP); Tsutomu Honda, Osaka (JP)

Correspondence Address: BRINKS HOFER GILSON & LIONE, P.O. BOX 10395, CHICAGO, IL, 60610, US

(73) Assignee: KONICA MINOLTA PHOTO IMAGING, INC.

(21) Appl. No.: 11/222,696

(22) Filed: Sep. 7, 2005

(30) Foreign Application Priority Data
May 16, 2005 (JP) 2005-142144

(51) Int. Cl. G03B 17/00

(52) U.S. Cl. 396/55

(57) ABSTRACT

An image sensing apparatus is provided with an image sensor for photoelectrically converting received light into an electrical signal, a photographing optical system having an image circle larger than an area of the imaging plane of the image sensor for forming an optical image of a subject onto an imaging plane of the image sensor, and a driving section for driving the image sensor over a plane perpendicular to an optical axis of the photographing optical system, and a shift photographing mode for performing a photographing in a state that the center of the imaging plane of the image sensor is shifted from the optical axis of the photographing optical system.

This application is based on Japanese Patent Application No. 2005-142144 filed on May 16, 2005, the contents of which are hereby incorporated by reference.

### BACKGROUND OF THE INVENTION

1. Field of the Invention

The present invention relates to an image sensing apparatus capable of performing shift photographing.

2. Description of the Related Art

Japanese Unexamined Patent Publication No. 7-128582 discloses an arrangement that a photographic area is moved by incorporating a shift lens in a photographing optical system and by moving the shift lens on a plane perpendicular to the optical axis of the photographing optical system.

There is known a photographing technique called “aori” in Japanese (hereinafter, called as “shift photographing”), wherein a photographic area is moved by moving a specific lens element on a plane perpendicular to the optical axis of a photographing optical system in order to suppress the likelihood that an upper part of a captured image of an object such as a building shrinks or is distorted in capturing the image of the building from below. Hereinafter, the lens element dedicatedly used for the shift photographing is called as a “shift lens”.

Further, there has been proposed a technique in an image sensing apparatus loaded with an image sensor, wherein misalignment of the optical axis of a photographing optical system is corrected by moving the image sensor on a plane perpendicular to the optical axis of the photographing optical system in such a direction as to cancel shake of the apparatus in the case where the misalignment occurs due to application of an external force to the apparatus by a photographer such as shake of the apparatus.

In the conventional technique of moving the photographic area by moving the shift lens in shift photographing, it is necessary to produce shift lenses individually depending on the type of the photographing optical system to be loaded, particularly, depending on the size of an image circle of the photographing optical system. Particularly, in the case where an image sensing apparatus such as a camera is used with an exchangeable lens unit, a user of the camera is required to purchase a shift lens as an optional part, which involves a cumbersome operation.

Further, the conventional arrangement constructed such that the image sensor is moved on the plane perpendicular to the optical axis of the photographing optical system has been proposed to correct misalignment of the optical axis of the photographing optical system resulting from shake of the apparatus, and has no relation to the technology of suppressing the likelihood that an upper part of a captured image of a building shrinks or is distorted in capturing the image of the building from below, as mentioned above.

### SUMMARY OF THE INVENTION

It is an object of the present invention to provide an image sensing apparatus which is free from the problems residing in the prior art.

It is another object of the present invention to provide an image sensing apparatus which enables to perform shift photographing without the need of attaching a dedicated shift lens and irrespective of a photographing optical system to be loaded.

According to an aspect of the invention, an image sensing apparatus is provided with an image sensor having an imaging plane for photoelectrically converting received light into an electrical signal, a photographing optical system having an image circle larger than an area of the imaging plane of the image sensor, a driving section for driving the image sensor over a plane perpendicular to an optical axis of the photographing optical system. The image sensing apparatus is further provided with a controller for controlling the driving section to enable a shift photographing of executing photographing in a state that the center of the imaging plane of the image sensor is shifted from the optical axis of the photographing optical system.

These and other objects, features and advantages of the present invention will become more apparent upon reading of the following detailed description along with the accompanying drawings.

### BRIEF DESCRIPTION OF THE DRAWINGS

FIG. 1 is a front view showing an external appearance of an image sensing apparatus embodying the invention.

FIG. 2 is a rear view showing the external appearance of the image sensing apparatus.

FIG. 3 is an illustration showing an internal arrangement of the image sensing apparatus.

FIGS. 4A and 4B are illustrations each showing a support/drive mechanism of an image sensor.

FIGS. 5A and 5B are illustrations each showing an arrangement of an X-axis actuator or an Y-axis actuator, wherein FIG. 5A is an explosive perspective view of the X-axis actuator or the Y-axis actuator, and FIG. 5B is an illustration showing an assembled state of the X-axis actuator or the Y-axis actuator.

FIG. 6 is a graph showing a drive pulse to be applied to a piezoelectric device of the X-axis actuator or to the Y-axis actuator.

FIG. 7 is a block diagram showing an electrical configuration of the entirety of the image sensing apparatus in a state that a lens unit is attached to an apparatus body.

FIG. 8 is an illustration showing an exemplary image on a display screen of an optical viewfinder.

FIG. 9 is an illustration showing a state that marks representing an image capturing area of the image sensor are displayed on the display screen of the optical viewfinder, specifically a state that display positions of the marks are moved.

FIG. 10 is an illustration showing an optical subject image formed on an imaging plane of the image sensor.

FIGS. 11A through 11D are illustrations showing positional relations between an image circle IS of a photographing optical system in a lens unit, and an image capturing area X of the image sensor.

FIG. 12 is a flowchart showing a processing of shift photographing mode.

FIG. 13 is a flowchart showing how anti-shake mode and shift photographing mode are selectively set in the case where the image sensing apparatus is loaded with the anti-shake mode and the shift photographing mode.

FIG. 14 is an illustration showing an altered manner as to how an image capturing area of an image sensor is displayed in an image sensing apparatus constructed such that the display area or the angle of view of an optical viewfinder is identical to the image capturing area of the image sensor

### DETAILED DESCRIPTION OF THE PREFERRED EMBODIMENTS OF THE INVENTION

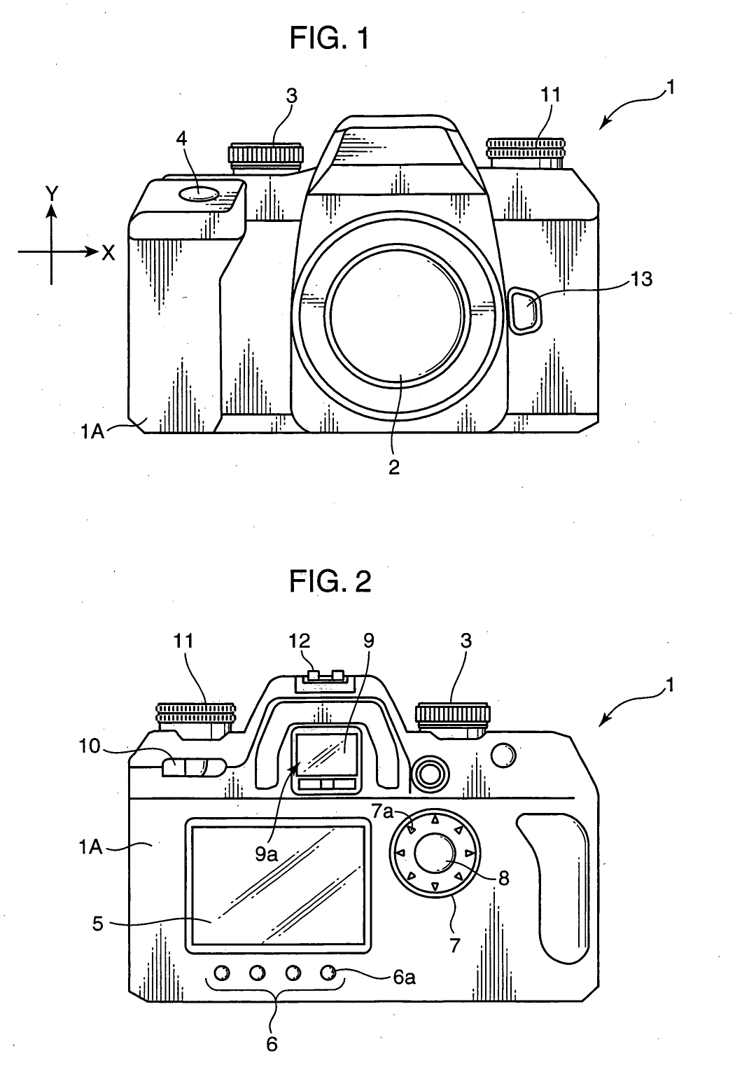

Referring to FIGS. 1 and 2 showing an image sensing apparatus embodying the invention, the image sensing apparatus 1 is a single lens reflex image sensing apparatus constructed such that a lens unit 2, which is an exchangeable part, is exchangeably or detachably attached to a box-shaped main body 1A.

The image sensing apparatus 1 comprises the lens unit 2 which is attached to a substantially middle part on a front face of the main body 1A, a first mode setting dial 3 which is arranged at an appropriate position on an upper face of the main body 1A, a shutter button 4 which is arranged at a corner portion on the upper face of the main body 1A, a liquid crystal display (LCD) 5 which is arranged on a left side of a rear face of the main body 1A in FIG. 2, a setting button group 6 which is arranged on a lower part relative to the LCD 5, a jog dial 7 which is arranged on a side of the LCD 5, a push button 8 which is arranged at a radially inner position of the jog dial 7, an optical viewfinder 9 which is arranged at an upper part relative to the LCD 5, a main switch 10 which is arranged on a side of the optical viewfinder 9, a second mode setting dial 11 which is arranged in the vicinity of the main switch 10, and a connecting terminal portion 12 which is arranged on the top part of the main body 1A above the optical viewfinder 9.

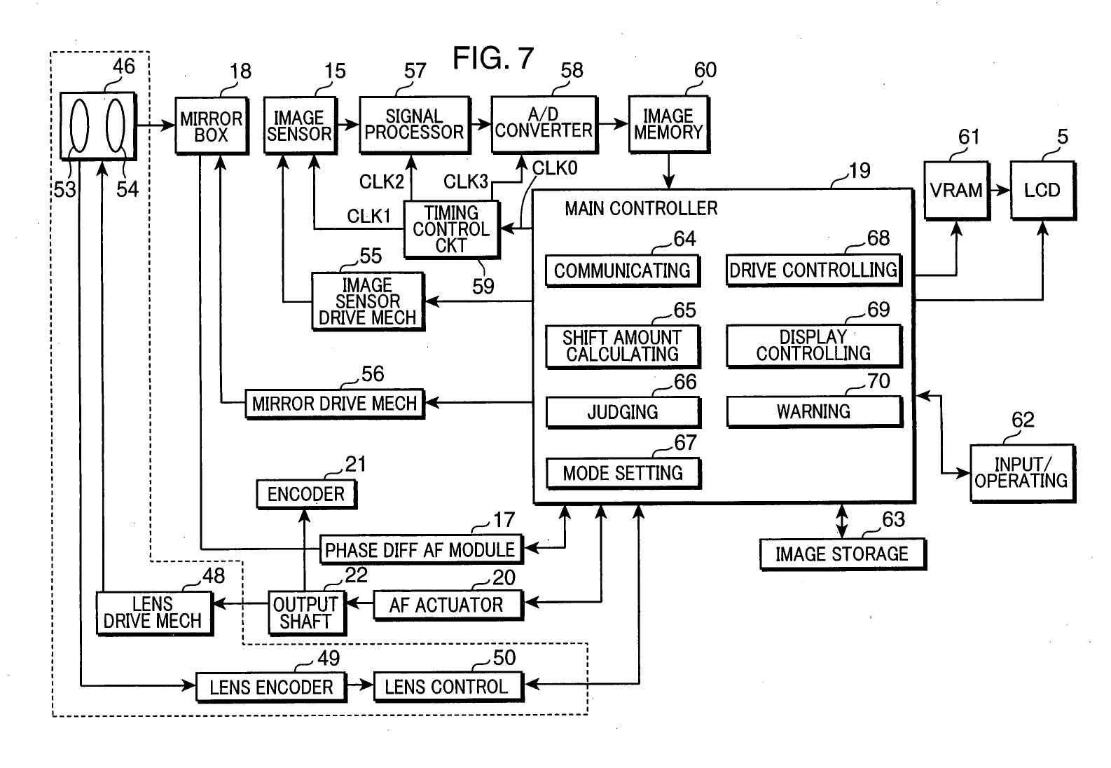

The lens unit 2 is constructed in such a manner that lens elements serving as optical devices are arrayed inside a lens barrel in a direction perpendicular to the plane of FIG. 1. A photographing optical system 46 (see FIG. 7) includes a zoom lens element 53 (see FIG. 7) for zooming, and a focus lens element 54 (see FIG. 7) for focus control, as optical elements to be incorporated in the lens unit 2. The zoom lens elements 53 and the focus lens element 54 perform zooming and focus control by being driven in an optical axis direction of the photographing optical system 46, respectively.

The lens unit 2 includes an unillustrated rotatable operation ring, which is provided at an appropriate position on an outer circumferential portion of the lens barrel along the outer circumference thereof. The zoom lens element 53 is manually movable to an intended position in the optical axis direction in accordance with a rotation direction and an angular displacement of the operation ring to attain a designated zoom ratio corresponding to the intended position. The lens unit 2 is detachable from the main body 1A by pressing a detachment button 13.

The first mode setting dial 3 has a substantially disc-like shape and is made pivotally rotatable on a plane substantially parallel to the upper face of the image sensing apparatus 1. The first mode setting dial 3 is adapted to select one of various modes or functions loaded in the image sensing apparatus 1 such as a mode of capturing a still image, a mode of capturing a moving image, and a mode of playing back a recorded image. Although not illustrated, characters or symbols respectively representing the functions of the image sensing apparatus 1 are marked at a certain interval on the upper face of the first mode setting dial 3 along the outer perimeter thereof, so that the function corresponding to the character or the symbol designated by a pointer provided at an appropriate position on the main body 1A can be executed.

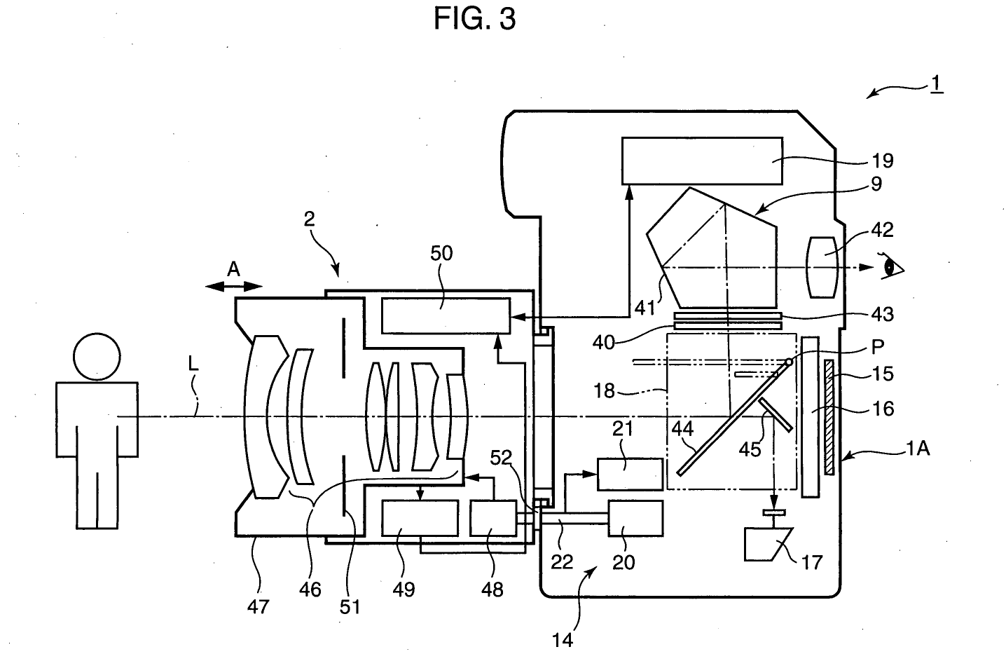

The shutter button 4 is of a depressing type, and is operable in two states, namely, a halfway pressed state and a fully pressed state. The shutter button 4 is adapted to designate a timing of an exposure operation to be implemented by an image sensor 15 (see FIGS. 3 and 7), which will be described later. When the shutter button 4 is pressed halfway down, the image sensing apparatus 1 is brought to an image capturing standby state, wherein setting of an exposure control value such as a shutter speed and an aperture value is conducted with use of a detection signal sent from an unillustrated AE sensor. When the shutter button 4 is pressed fully down, an exposure operation by the image sensor 15 is initiated to generate an image of a subject to be recorded in an image storage 63 (see FIG. 7), which will be described later. The halfway pressed state of the shutter button 4 is detected in response to turning on of a switch S1 (not shown), and the fully pressed state of the shutter button 4 is detected in response to turning on of a switch S2 (not shown).

The LCD 5 includes a color liquid crystal display panel. The LCD 5 is adapted to display an image captured by the image sensor 15, to play back a recorded image, and to display a screen image for setting a function or a mode loaded in the image sensing apparatus 1. An organic electroluminescent device or a plasma display device may be used in place of the LCD 5.

The setting button group 6 is a group of buttons for allowing a user to designate various functions loaded in the image sensing apparatus 1. In this embodiment, the setting button group 6 includes a shift photographing mode button 6a for designating shift photographing mode. The shift photographing mode is a mode for capturing an image in a state that the center of an imaging plane of the image sensor 15 is shifted from the optical axis of the photographing optical system 46 (see FIGS. 3 and 7) on a plane perpendicular to the optical axis of the photographing optical system 46. When the shift photographing mode is set, the user is enabled to perform shift photographing.

The jog dial 7 includes an annular member provided with plural pressing portions 7a indicated by triangular marks shown in FIG. 2 which are arrayed at a certain interval in a circumferential direction of the annular member. The jog dial 7 is constructed in such a manner that a contact or a switch (not shown) provided in correspondence to each one of the pressing portions 7a of the jog dial 7 detects whether the corresponding pressing portion has been manipulated. The push button 8 is arranged in the middle of the jog dial 7. With use of the jog dial 7 and the push button 8, the user is allowed to input designation regarding feeding of frames of recorded images to be played back on the LCD 5, setting of photographing conditions such as the aperture value, the shutter speed, firing/non-firing of flash, and the like.

As mentioned above, the image sensing apparatus 1 is loaded with the shift photographing mode. In this embodiment, movement of the image sensor 15 in the shift photographing mode can be designated by manipulating the jog dial 7. For instance, when one of the pressing portions 7a of the jog dial 7 shown in FIG. 2 is pressed, the image sensor 15 is driven in such a manner that an image capturing area of the image sensor 15 is moved in a direction corresponding to the designated pressing portion 7a by a moving distance corresponding to the number of times of pressing the pressing portion 7a. When the push button 8 is pressed, the image sensor 15 is returned to the central position where the center of the imaging plane of the image sensor 15 is aligned with the optical axis of the photographing optical system 46, namely, to the home position.

The optical viewfinder 9 is adapted to optically display the image capturing area. The main switch 10 is a slide switch of 2-contact, which slides in sideways directions of the image sensing apparatus 1. When the main switch 10 is slid leftward, the main power of the image sensing apparatus 1 is turned on, and when the main switch 10 is slid rightward, the main power of the image sensing apparatus 1 is turned off.

The second mode setting dial 11 has a mechanical construction similar to that of the first mode setting dial 3. With the second mode setting dial 11, the user is allowed to manipulate the various functions loaded in the image sensing apparatus 1. The connecting terminal portion 12 is a terminal for connecting the image sensing apparatus 1 to an external device such as an unillustrated flash device.

As shown in FIG. 3, the main body 1A is incorporated with an AF driving unit 14, the image sensor 15, a shutter unit 16, the optical viewfinder 9, a phase difference AF module 17, a mirror box 18, and a main controller 19.

The AF driving unit 14 includes an AF actuator 20, an encoder 21, and an output shaft 22. The AF actuator 20 has various motors such as a DC motor for generating a drive source, a stepping motor, and an ultrasonic motor, and an unillustrated speed reduction system for reducing the rotation number of each motor.

Briefly describing the encoder 21, the encoder 21 is adapted to detect a rotated amount of a motor which is transmitted from the AF actuator 20 to the output shaft 22. The detected rotated amount of the motor is used in calculating the position of the photographing optical system 46 in the lens unit 2. The output shaft 22 transmits a driving force of the motor outputted from the AF actuator 20 to a lens driving mechanism 48 provided in the lens unit 2, which will be described later.

The image sensor 15 is arranged at an appropriate position on the rear side of the main body 1A, with its imaging plane being perpendicular to the optical axis of the photographing optical system 46. The image sensor 15 is, for instance, a charge coupled device (CCD) color area sensor of a so-called “Bayer matrix” in which photoelectric conversion elements each constituted of a photodiode are arrayed two-dimensionally in a matrix, and patches of color filters in red (R), green (G), and blue (B) having different spectral characteristics from each other are attached on light receiving surfaces of the respective photoelectric conversion elements with a ratio of 1:2:1. The image sensor 15 converts an optical image of a subject formed by the photographing optical system 46 into analog electrical signals, namely, image signals of respective color components of R, G, and B for outputting.

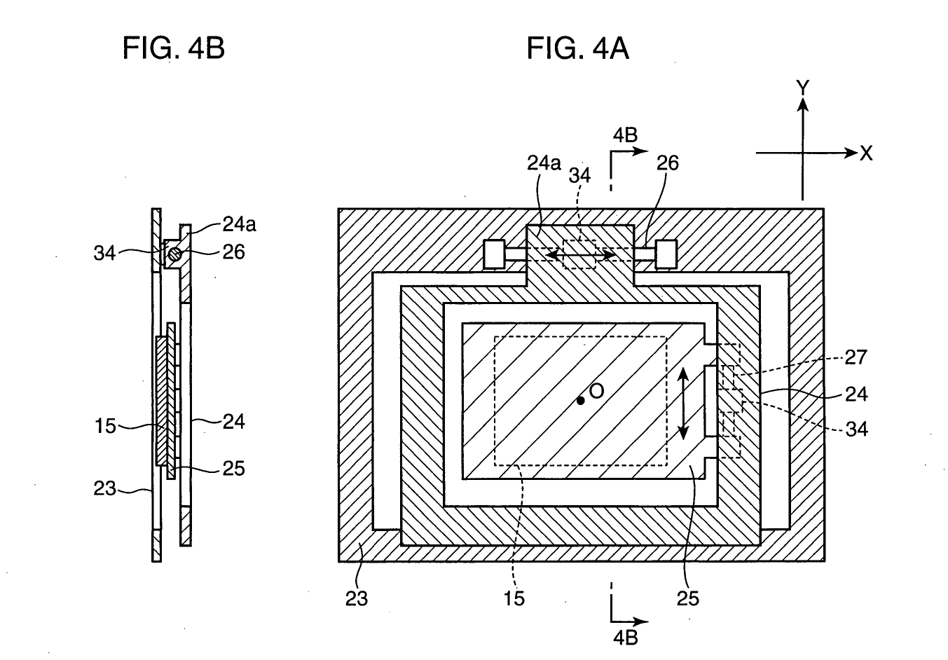

FIGS. 4A and 4B are illustrations each showing a support/drive mechanism of the image sensor 15. FIG. 4A is an illustration viewed from a side opposite to the imaging plane of the image sensor 15. FIG. 4B is a cross-sectional view taken along the line 4B-4B in FIG. 4A. As shown in FIG. 4A, a two-dimensional coordinate system is defined with respect to the imaging plane of the image sensor 15, wherein a longer side direction or a horizontal direction of the imaging plane is set as X-axis direction, and a shorter side direction or a vertical direction thereof is set as Y-axis direction. The two-dimensional coordinate system shown in FIG. 4A corresponds to a two-dimensional coordinate system as shown in FIG. 1.

The support/drive mechanism for the image sensor 15 has a first base plate 23 of a substantially rectangular shape, a second base plate 24, a third base plate 25, an X-axis actuator 26, and an Y-axis actuator 27. The first base plate 23 has a hollow rectangular portion, and is secured to the main body 1A. The X-axis actuator 26 is arranged at a middle position on an upper rear surface of the first base plate 23. The second base plate 24 has a hollow rectangular portion, and is interconnected to the X-axis actuator 26. The Y-axis actuator 27 is arranged at a middle position on a right side part of a front surface of the second base plate 24. The third base member 25 is a planar member interconnected to the Y-axis actuator 27. The image sensor 15 is fixedly attached to a front surface of the third base plate 25. The second base plate 24 is movable in the X-axis direction, namely, in the directions of the leftward arrow and the rightward arrow in FIG. 4A, and the third base plate 25 is movable in the Y-axis direction, namely, in the directions of the upward arrow and the downward arrow in FIG. 4A along respective rails (not shown) relative to their respective home positions.

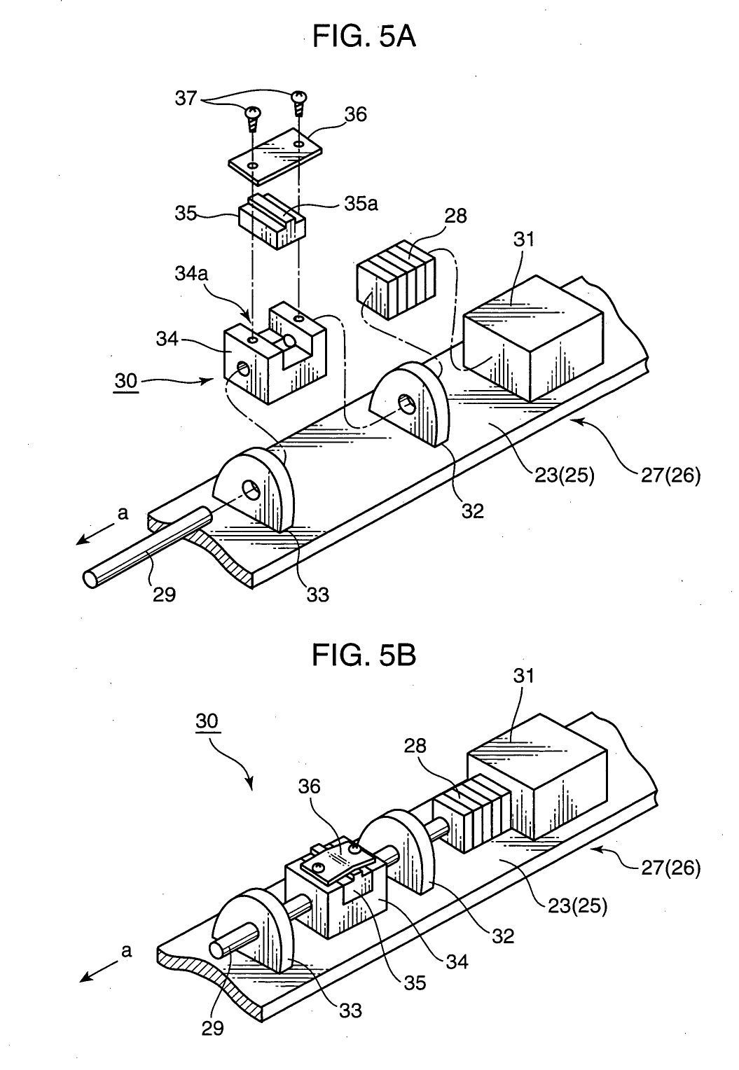

FIGS. 5A and 5B are illustrations each showing an arrangement of the X-axis actuator 26 (Y-axis actuator 27). FIG. 5A is an explosive perspective view of the X-axis actuator 26 (Y-axis actuator 27), and FIG. 5B is an illustration showing an assembled state of the X-axis actuator 26 (Y-axis actuator 27).

As shown in FIGS. 5A and 5B, the X-axis actuator 26 and the Y-axis actuator 27 have constructions substantially identical to each other. The X-axis actuator 26 (Y-axis actuator 27) has a piezoelectric device 28, a drive shaft 29 which is fixed to one end of the piezoelectric device 28 by an adhesive, and a frictional engaging unit 30 which is frictionally engaged with the drive shaft 29.

The piezoelectric device 28 is constituted of plural piezoelectric elements placed one over the other in a certain direction by an adhesive. When an electric voltage is applied to the piezoelectric device 28, the piezoelectric device 28 is expanded or contracted depending on the applied voltage. The piezoelectric device 28 has the other end thereof secured to a support block 31 on the first base plate 23 or on the third base plate 25 by an adhesive. The drive shaft 29 is received in support members 32 and 33 on the first base plate 23 or on the third base plate 25, so that the drive shaft 29 is movable in the arrayed direction of the piezoelectric elements constituting the piezoelectric device 28. When a force is acted upon the piezoelectric device 28 secured to an end of the drive shaft 29 by an adhesive in such a direction as to expand or contract the piezoelectric device 28 in the thickness direction of the piezoelectric device 28, the drive shaft 29 is moved in the axial direction thereof.

The frictional engaging unit 30 includes a slider 34 which is adapted to receive the drive shaft 29 and is frictionally engaged with the drive shaft 29 at a lower part of the frictional engaging unit 30, a pad member 35 which is fitted in a cutaway 34a formed in an upper part of the slider 34, and is frictionally engaged with the drive shaft 29 at an upper part of the frictional engaging unit 30, and a plate spring 36 for regulating a frictional engaging force of the drive shaft 29 with the slider 34 and with the pad member 35. A projecting rib 35a formed on the pad member 35 is contacted against the plate spring 36. The frictional engaging force of the drive shaft 29 with the slider 34 and with the pad member 35 can be controlled by regulating fastening forces of screws 37, 37 which fasten the plate spring 36 to the slider 34.

Referring to FIGS. 5A and 5B, as well as FIGS. 4A and 4B, the second base plate 24 is described. The second base plate 24 has an extension 24a which extends upward from the middle part on an upper peripheral portion of the second base plate 24. The slider 34 of the X-axis actuator 26 is integrally attached to the extension 24a of the second base plate 24 at the front surface thereof opposing to the first base plate 23. The first base plate 23 and the second base plate 24 are interconnected with each other by way of a frictional engagement of the slider 34 with the drive shaft 29 of the X-axis actuator 26, whereby the second base plate 24 is movable relative to the first base plate 23 in the X-axis direction.

Further, the slider 34 of the Y-axis actuator 27 is integrally attached to the middle position on the right side part of the front surface of the second base plate 24 opposing to the first base plate 23. The third base plate 25 and the second base plate 24 are interconnected with each other by way of a frictional engagement of the slider 34 with the drive shaft 29 of the Y-axis actuator 27, whereby the third base plate 25 is movable relative to the second base plate 24 in the Y-axis direction.

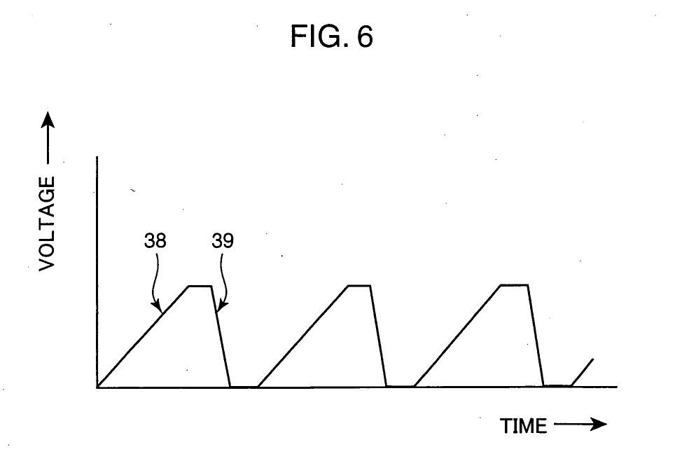

A drive pulse having a waveform comprised of a moderate rising part 38 followed by a sharp falling part 39 is applied to the piezoelectric device 28 of the X-axis actuator 26 (Y-axis actuator 27), as shown in FIG. 6. When the moderate rising part 38 of the drive pulse is applied to the piezoelectric device 28, the piezoelectric device 28 is slowly expanded in the thickness direction thereof, with the result that the drive shaft 29 is displaced in the direction of the arrow a (see FIGS. 5A and 5B). As a result, the second base plate 24 is moved in the direction of the arrow a due to the frictional engagement of the frictional engaging unit 30 with the drive shaft 29, and the third base plate 25 is moved in the direction of the arrow a together with the movement of the second base plate 24, as the drive shaft 29 is displaced in the direction of the arrow a. The direction of the arrow a corresponds to the X-axis direction in the case where the X-axis actuator 26 is driven, and corresponds to the Y-axis direction in the case where the Y-axis actuator 27 is driven.

On the other hand, when the sharp falling part 39 of the drive pulse is applied to the piezoelectric device 28, the piezoelectric device 28 is rapidly contracted in the thickness direction thereof, with the result that the drive shaft 29 is displaced in the direction opposite to the arrow a. At this time, the second base plate 24 which is in the frictional engagement of the frictional engaging unit 30 with the drive shaft 29 of the X-axis actuator 26, and the third base plate 25 which is moved along with the driving of the drive shaft 29 of the Y-axis actuator 27 stay substantially in their respective positions due to the inertial force against the frictional engaging force of the drive shaft 29 and the frictional engaging unit 30, and are kept unmoved. The phrase “stay substantially” in this context embraces a case that the second base plate 24 and the third base plate 25 are moved in the direction of the arrow a as a whole due to a time lag in driving the second base plate 24 and the third base plate 25, as a result of sliding contact of the drive shaft 29 and the frictional engaging unit 30 which are secured to the second base plate 24 and the third base plate 25, and accompanied movement resulting from the sliding contact in the direction of the arrow a, and in the direction opposite to the arrow a. The moving directions of the second base plate 24 and the third base plate 25 are determined depending on the frictional condition to be applied.

In this way, by successively applying the drive pulse having the waveform as shown in FIG. 6 to the piezoelectric device 28, the image sensor 15 is movable in the plus direction of the X-axis, namely, in the rightward X-axis direction in FIG. 4A, and in the plus direction of the Y-axis, namely, in the upward Y-axis direction in FIG. 4A sequentially. Likewise, the image sensor 15 is movable in the minus direction of the X-axis, namely, in the leftward X-axis direction in FIG. 4A, and in the minus direction of the Y-axis, namely, in the downward Y-axis direction in FIG. 4A, in other words, in the direction opposite to the arrow a sequentially by inverting polarities of electrodes of the piezoelectric device 28 and by applying a drive pulse having the waveform as shown in FIG. 6.

In the above arrangement, in the case where the shift photographing mode is set, in response to pressing of one of the pressing portions 7a of the jog dial 7, the above drive pulse is applied to the piezoelectric device 28 of the X-axis actuator 26 (Y-axis actuator 27) to expand or contract the piezoelectric device 28 of the X-axis actuator 26 (Y-axis actuator 27). In response to the expansion or the contraction of the piezoelectric device 28, the second base plate 24 is moved relative to the first base plate 23 in the X-axis direction by the X-axis actuator 26, and the third base plate 25 is moved relative to the second base plate 24 in the Y-axis direction by the Y-axis actuator 27, whereby the image sensor 15 is moved in an intended X-axis direction or in an intended Y-axis direction. When the pressing operation of the jog dial 7 is released, supply of the drive pulse is suspended, and the driving of the image sensor 15 is suspended. The position of the image sensor 15 is detected by an unillustrated position sensor.

Returning to FIG. 3, the shutter unit 16 has a focal plane shutter (hereinafter, simply called as a “shutter”). The shutter unit 16 is provided between the rear face of the mirror box 18 and the image sensor 15.

The optical viewfinder 9 is arranged above the mirror box 18 which is disposed substantially in the middle of the main body 1A. The optical viewfinder 9 has a focusing glass 40, a prism 41, and an eyepiece element 42. The prism 41 laterally reverses an image of the subject formed on the focusing glass 40, and guides the laterally-reversed subject image to the eye of the photographer via the eyepiece element 42, so that the photographer can visually recognize the subject image.

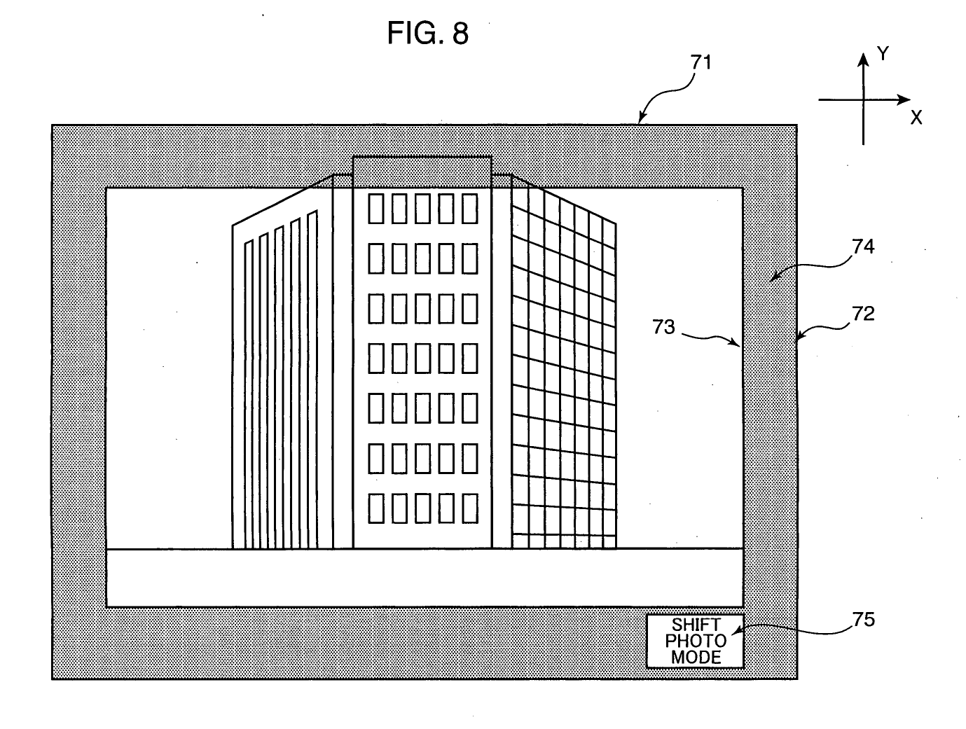

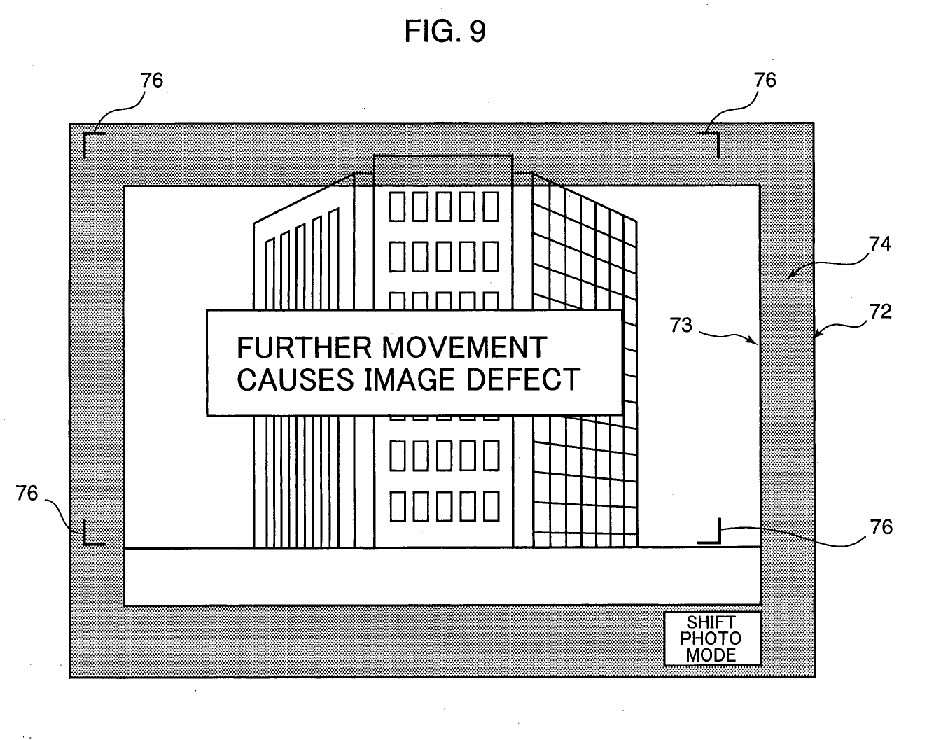

A liquid crystal display plate 43 is arranged on the optical path between the focusing glass 40 and the prism 41. As will be describe later, the liquid crystal display plate 43 causes a mode display section 75 (see FIG. 8) to display the name of the designated mode or the shift photographing mode when the shift photographing mode is designated, and causes the display screen of the optical viewfinder 9 to display marks 76 (see FIG. 9), which represent the image capturing area that has been moved by driving of the image sensor 15 in response to manipulation of the jog dial 7.

The phase difference AF module 17 is arranged underneath the mirror box 18, and is adapted to detect the focal position by a well-known phase difference detecting system. A detailed construction of the phase difference AF module 17 is omitted because of the disclosure in a number of U.S. patents and other literatures, e.g., U.S. Pat. No. 5,974,271.

The mirror box 18 has a quick return mirror 44 and a sub mirror 45. The position of the quick return mirror 44 is pivotally changeable about a pivot pin P between a position as shown by the solid line in FIG. 3 (hereinafter, called as a “tilt position of the quick return mirror 44”) where the quick return mirror 44 is titled by about 45 degrees with respect to the optical axis L of the photographing optical system 46, and a position as shown by the imaginary line in FIG. 3 (hereinafter, called as a “horizontal position of the quick return mirror 44”) where the quick return mirror 44 is aligned substantially parallel to the bottom face of the main body 1A.

The sub mirror 45 is arranged behind the quick return mirror 44, namely, on the side of the image sensor 15. The position of the sub mirror 45 is changeable in association with the movement of the quick return mirror 44 between a position as shown by the solid line in FIG. 3 (hereinafter, called as a “tilt position of the sub mirror 45”) where the sub mirror 45 is titled by about 90 degrees with respect to the quick return mirror 44 at the tilt position, and a position as shown by the imaginary line in FIG. 3 (hereinafter, called as a “horizontal position of the sub mirror 45”) where the sub mirror 45 is aligned substantially parallel to the quick return mirror 44 at the horizontal position. The quick return mirror 44 and the sub mirror 45 are driven by a mirror driving mechanism 56 (see FIG. 7), which will be described later.

While the quick return mirror 44 and the sub mirror 45 are set at their respective tilt positions, namely, for a period until the shutter button 4 is brought to a fully pressed state (hereinafter, called as a “photographing preparatory period”), the quick return mirror 44 guides a large part of rays of light that have been propagated through the photographing optical system 46 onto the focusing glass 40 for reflection, while allowing the remaining part of the rays of light to pass, and the sub mirror 45 guides the rays of light that have passed through the quick return mirror 44 to the phase difference AF module 17. At this time, the subject image is displayed on the optical viewfinder 9, and focus control is executed by the phase difference AF module 17. However, since the rays of light are not introduced to the image sensor 15 during the photographing preparatory period, the subject image is not displayed on the LCD 5.

On the other hand, when the quick return mirror 44 and the sub mirror 45 are set to their respective horizontal positions, namely, when the shutter button 4 is brought to a fully pressed state, the quick return mirror 44 and the sub mirror 45 are retracted from the optical axis L. Accordingly, substantially all the rays that have been propagated through the photographing optical system 46 are introduced to the image sensor 15. At this time, although the subject image is displayed on the LCD 5, the subject image is not displayed on the optical viewfinder 9, and focus control by the phase difference AF module 17 is not implemented.

The main controller 19 includes a micro computer in which a storage such as an ROM for storing a control program, and a flash memory for temporarily storing data is incorporated. The function of the main controller 19 will be described later in detail.

Now, the lens unit 2 to be attached to the main body 1A is described. As shown in FIG. 3, the lens unit 2 has the photographing optical system 46, a lens barrel 47, the lens driving mechanism 48, a lens encoder 49, and a lens controlling section 50.

The photographing optical system 46 is constructed in such a manner that the zoom lens 53 (see FIG. 7) for changing the zoom ratio or the focal length, the focus lens 54 (see FIG. 7) for controlling the focal position, a diaphragm 51 for controlling the amount of light to be irradiated onto the image sensor 15 or a like device provided in the main body 1A are held in the lens barrel 47 in the direction of the optical axis L to guide an optical subject image and to form the optical subject image onto the image sensor 15 or a like device. The focus control operation is conducted by driving the photographing optical system 46 in the direction of the optical axis L by the AF actuator 20 provided in the main body 1A.

The lens driving mechanism 48 includes a helicoid and an unillustrated gear for rotating the helicoid. The lens driving mechanism 48 is adapted to move the photographing optical system 46 as a unit in the direction of the arrow A parallel to the optical axis L upon receiving a driving force from the AF actuator 20 by way of a coupler 52. The moving direction and the moving distance of the photographing optical system 46 are determined based on the rotation direction and the rotation number of the AF actuator 20, respectively.

The lens encoder 49 includes an encoder plate in which plural code patterns are formed at a certain pitch in the direction of the optical axis L within a movable range of the photographing optical system 46, and an encoder brush which is integrally moved with the lens barrel 47 in sliding contact with the encoder plate. The lens encoder 49 is adapted to detect the moving distance of the photographing optical system 46 at the time of focus control.

The lens controlling section 50 is adapted to provide storage contents to a main controller 19 in the main body 1A in response to attachment of the lens unit 2 to the main body 1A, and in response to data request from the main controller 19. The storage contents include data regarding an image circle of the photographing optical system 46 loaded in the lens unit 2. The image circle is a circular area within which an image satisfying photographing requirements can be formed by the photographing optical system 46 in the lens unit 2.

Next, an electrical configuration of the image sensing apparatus 1 embodying the invention is described. FIG. 7 is a block diagram showing the electrical configuration of the entirety of the image sensing apparatus 1 in a state that the lens unit 2 is attached to the main body 1A. Elements in FIG. 7 which are equivalent to those in FIGS. 1 through 3 are denoted at the same reference numerals. The parts shown by the dotted lines in FIG. 7 represent parts to be loaded in the lens unit 2.

A photographing optical system 46 shown in FIG. 7 corresponds to the photographing optical system 46 shown in FIG. 3, and includes a zoom lens 53 for changing the zoom ratio or the focal length, and a focus lens 54 for controlling the focal position. An AF actuator 20, an encoder 21, an output shaft 22, a lens driving mechanism 48, and a lens encoder 49 shown in FIG. 7 correspond to the AF actuator 20, the encoder 21, the output shaft 22, the lens driving mechanism 48, and the lens encoder 49 shown in FIG. 3, respectively. A lens controlling section 50 shown in FIG. 7 corresponds to the lens controlling section 50 shown in FIG. 3. A mirror box 18 shown in FIG. 7 corresponds to the mirror box 18 shown in FIG. 3, and includes a quick return mirror 44, and a sub mirror 45. A phase difference AF module 17 shown in FIG. 7 corresponds to the phase difference AF module 17 shown in FIG. 3. An image sensor 15 shown in FIG. 7 corresponds to the image sensor 15 shown in FIG. 3. Image capturing operations such as start and end of an exposure operation of the image sensor 15, and readout of pixel signals from the respective pixels of the image sensor 15 including horizontal synchronization, vertical synchronization, and transfer are controlled by a timing controlling circuit 59, which will be described later.

An image sensor driving mechanism 55 is adapted to drive the image sensor 15 on a plane perpendicular to the optical axis of the photographing optical system 46, and includes the piezoelectric device 28, the drive shaft 29, and the frictional engaging unit 30. A mirror driving mechanism 56 is adapted to drivingly change the positions of the quick return mirror 44 and the sub mirror 45 between their respective tilt positions and horizontal positions. Operations of the image sensor driving mechanism 55 and the mirror driving mechanism 56 are controlled by a main controller 19.

A signal processor 57 is adapted to apply a predetermined analog signal processing to an analog image signal outputted from the image sensor 15. The signal processor 57 includes a correlation double sampling (CDS) circuit, and an auto gain control (AGC) circuit. The CDS circuit performs noise reduction of the image signal, and the AGC circuit performs level adjustment of the image signal.

An analog-to-digital (A/D) converter 58 is adapted to convert analog pixel signals of R, G, and B outputted from the signal processor 57 into respective digital pixel signals (hereinafter, called as “pixel data”) of plural bits e.g. 10 bits.

The timing controlling circuit 59 generates clocks CLK1, CLK2, and CLK3 based on a reference clock CLK0 outputted from the main controller 19. The timing controlling circuit 59 controls operations of the image sensor 15, the signal processor 57, and the A/D converter 58 by outputting the clock CLK1 to the image sensor 15, the clock CLK2 to the signal processor 57, and the clock CLK3 to the A/D converter 58, respectively.

An image memory 60 is a memory for temporarily storing image data outputted from the A/D converter 58, and is used as a work area where various processing are carried out with respect to the image data by the main controller 19 when the image sensing apparatus 1 is in the photographing mode. The image memory 60 serves as a memory for temporarily storing image data read out from an image storage 63, which will be described later, when the image sensing apparatus 1 is in the playback mode.

A VRAM 61 has a storage capacity capable of recording image signals corresponding to the number of pixels of a LCD 5, and serves as a buffer memory for storing pixel data constituting an image to be played back on the LCD 5. The LCD 5 shown in FIG. 7 corresponds to the LCD 5 shown in FIG. 2.

An input operating section 62 is constituted of the first mode setting dial 3, the shutter button 4, the setting button group 6, the jog dial 7, the push button 8, the main switch 10, and the second mode setting dial 11. Through the input operating section 62, information relating to an operation of the image sensing apparatus 1 is inputted to the main controller 19. The image storage 63 includes a memory card and a hard disk, and is adapted to store image data generated in the main controller 19.

The main controller 19 corresponds to the main controller 19 shown in FIG. 3, and is adapted to control driving of the respective parts in the image sensing apparatus 1 shown in FIG. 7 in association with each other. The main controller 19 functionally has a communicating section 64, a shift amount calculating section 65, a judging section 66, a mode setting section 67, a drive controlling section 68, a display controlling section 69, and a warning section 70 to realize the aforementioned shift photographing mode.

The communicating section 64 communicates various data with the lens controlling section 50 of the lens unit 2 attached to the main body 1A. When the lens unit 2 is attached to the main body 1A for the first time, the communicating section 64 receives, from the lens unit 2, data concerning the image circle of the photographing optical system 64 in the lens unit 2. Hereinafter, the data concerning the image circle of the photographing optical system 46 is called as “image circle data”. Since the image circle data is varied depending on the focal length or the focal position, the communicating section 64 may receive the image circle data from the lens unit 2 again when the shutter button 4 is brought to a halfway pressed state, namely, when the switch S1 is turned on.

The shift amount calculating section 65 calculates an allowable moving range of the image sensor 15 based on the size of the image circle represented by the image circle data sent from the lens unit 2. The allowable moving range of the image sensor 15 has an upper limit within which the image sensor 15 is movable to such an extent as to avoid appearance of “vignetting” (darkening of an image in corner portions).

The judging section 66 judges whether the current position of the image sensor 15 is out of the area of the image circle of the photographing optical system 46 loaded in the lens unit 2 attached to the image sensing apparatus 1, based on the allowable moving range of the image sensor 15 calculated by the shift amount calculating section 65, and on the current position of the image sensor 15.

The mode setting section 67 sets the shift photographing mode or releases setting of the shift photographing mode each time the shift photographing mode button 6a is pressed. The mode setting section 67 releases setting of the shift photographing mode if the lens unit 2 is exchanged with another one while the image sensing apparatus 1 is in the shift photographing mode. The mode setting section 67 releases setting of the shift photographing mode if the judging section 66 judges that the current position of the image sensor 15 is out of the area of the image circle of a photographing optical system 46 loaded in the newly attached lens unit 2.

The drive controlling section 68 causes the image sensor driving mechanism 55 to drive the image sensor 15 based on an operated state of the jog dial 7 and within the allowable moving range of the image sensor 15 in response to manipulation of the jog dial 7 in the case where the shift photographing mode is set by way of the shift photographing mode button 6a. For instance, when one of the pressing portions 7a shown in FIG. 2 is pressed, the drive controlling section 68 causes the image sensor driving mechanism 55 to drive the image sensor 15 in such a manner that the image capturing area of the image sensor 15 is moved in an upper leftward direction corresponding to the operated pressing portion 7a by the moving distance corresponding to the number of times of pressing the pressing portion 7a.

The display controlling section 69 causes the liquid crystal display plate 43 to display the image capturing area of the image sensor 15 which has been moved in correspondence to the driving of the image sensor 15. FIG. 8 shows an image on a display screen of the optical viewfinder 9 in a state that the center of the imaging plane of the image sensor 15 is aligned with the optical axis of the photographing optical system 46, and when the photographing optical system 46 is substantially set opposed to a subject.

As shown in FIG. 8, the display screen 71 of the optical viewfinder 9 has an outer frame 72 and an inner frame 73. The area defined by the outer frame 72 is an area of the subject image viewable by the photographer when the photographer views the subject image through a finder frame 9a (see FIG. 2) of the optical viewfinder 9. The area defined by the inner frame 73 is an image capturing area of the image sensor 15 when the center of the imaging plane of the image sensor 15 is aligned with the optical axis of the photographing optical system 46. Specifically, the display area or the angle of view of the optical viewfinder 9 is set smaller than the image circle of the photographing optical system 46 and is larger than the image capturing area of the image sensor 15.

An image is displayed in an area 74 between the outer frame 72 and the inner frame 73 in a state that the luminance thereof is relatively smaller than that of the image displayed within the inner frame 73. The mode display section 75 is provided at an appropriate position on the area 74, e.g., a lower right corner portion on the area 74 in FIG. 8 to allow the photographer to visually recognize that the image sensing apparatus 1 is set to the shift photographing mode.

When one of the pressing portions 7a of the jog dial 7 is pressed a certain number of times in a state that the center of the imaging plane of the image sensor 15 is aligned with the optical axis of the photographing optical system 46, for instance, the imaging plane of the image sensor 15 is moved on the plane perpendicular to the optical axis of the photographing optical system 46 in response to manipulation of the pressing portion 7a, and as the imaging plane of the image sensor 15 is moved, the display controlling section 69 causes the marks 76 representing the image capturing area of the image sensor 15 to be displayed on the display screen, and moves the display positions of the marks, as shown in FIG. 9. The marks 76 are displayed at positions away from the inner frame 73 in a direction corresponding to the operated pressing portion 7a, namely, in the moving direction of the image sensor 15 by a distance corresponding to the moving distance of the image sensor 15, which corresponds to the number of times of pressing the pressing portion 7a.

The image capturing area of the image sensor 15 which has been moved by driving of the image sensor 15 is represented by the marks 76, so that the photographer can visually recognize the moved image capturing area through the optical viewfinder 9 for the following reason. Namely, rays of light are not introduced to the image sensor 15 during a photographing preparatory period, and accordingly, the photographer cannot confirm the subject image actually captured by the image sensor 15 on the LCD 5.

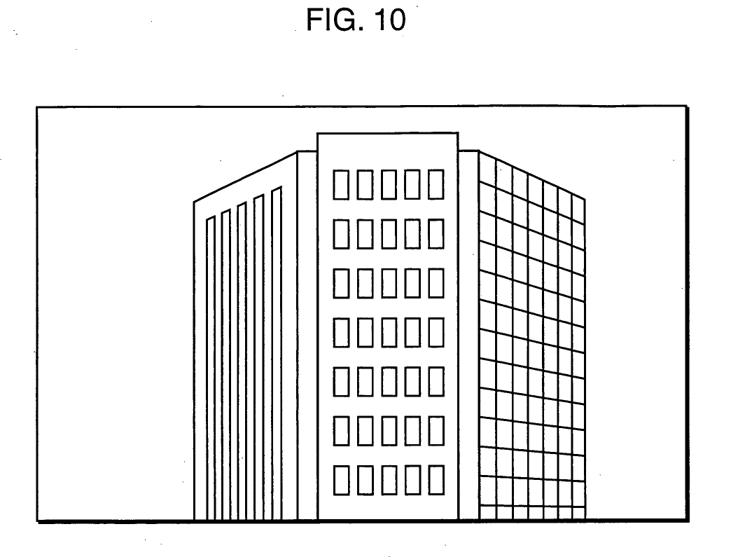

FIG. 10 is an illustration showing the image capturing area of the image sensor 15. Since an optical image corresponding to an upper part of a subject is not introduced onto the imaging plane of the image sensor 15 in the state as shown in FIG. 8, the optical image corresponding to the upper part of the subject cannot be captured by the image sensor 15 in this state. However, by moving the image sensor 15 in the aforementioned manner in the shift photographing mode, the upper optical image, namely, an optical image in an upper shaded area in FIGS. 8 and 9 can be captured as shown in FIG. 10, thereby enabling to perform shift photographing. The subject image displayed on the display screen of the optical viewfinder 9 is not moved irrespective of the driving of the image sensor 15.

Let us assume a two-dimensional coordinate system, wherein a horizontal direction of the display screen in FIG. 8 corresponds to an X-axis direction, and a vertical direction thereof corresponds to an Y-axis direction. Then, the warning section 70 causes the liquid crystal display plate 43 to display a warning message that vignetting may appear, such as “FURTHER MOVEMENT CAUSES IMAGE DEFECT” in the middle of the display screen of the optical viewfinder 9, as shown in FIG. 9, for instance, if designation is inputted through the jog dial 7 to move the image sensor 15 in a direction corresponding to at least one of the X-axis direction and the Y-axis direction by a distance exceeding the allowable moving range of the image sensor 15 calculated by the shift amount calculating section 65, e.g., if the number of times of pressing the pressing portion 7a of the jog dial 7 has reached a predetermined number, and restrains further outward movement of the image sensor 15 over the allowable moving range.

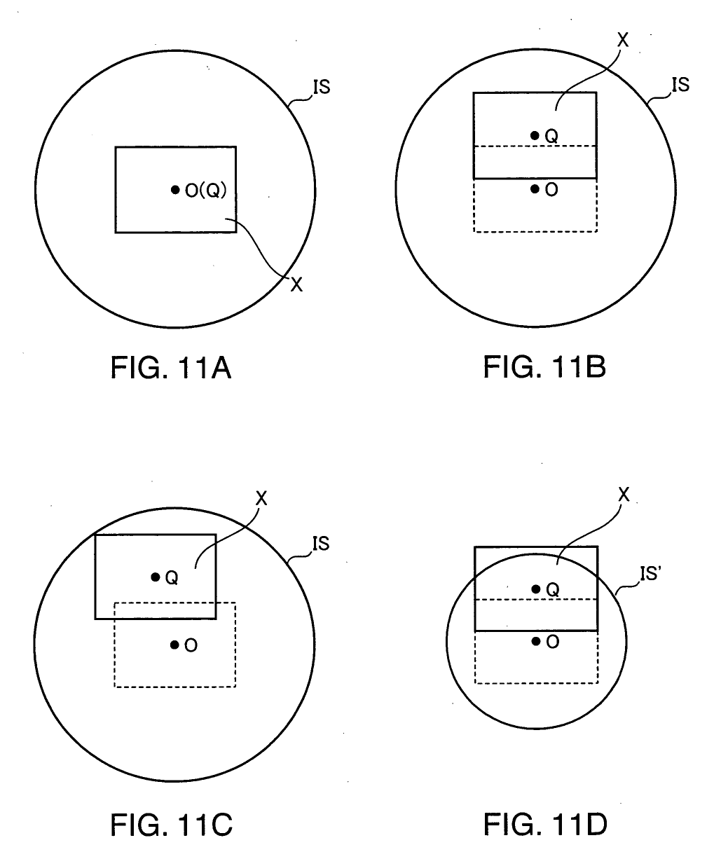

FIGS. 11A through 11D are illustrations showing some examples of positional relations between an image circle IS of the photographing optical system 46 in the lens unit 2, and an image capturing area X of the image sensor 15. FIG. 11A shows a state that the center Q of the image capturing area X is aligned with the optical axis O of the photographing optical system 46. FIG. 11B shows a state that the center Q of the image sensing area X is shifted from the optical axis O of the photographing optical system 46 as a result of driving of the image sensor 15, but the entirety of the image capturing area X lies within the image circle IS.

FIG. 11C is an illustration showing a state that the center Q of the image capturing area X is shifted from the optical axis O of the photographing optical system 46 as a result of driving of the image sensor 15, and that the image sensing area X is about to leave the image circle IS. The warning section 70 issues the warning message and restrains further movement of the image sensor 15 when the positional relation between the image sensor 15 and the photographing optical system 46 is in the state as shown in FIG. 11C.

FIG. 11D is an illustration showing a state that the current position of the image sensor 15 is out of an image circle IS′ at the time of attaching a lens unit 2 in the case where the lens unit 2 loaded with a photographing optical system 46 having the image circle IS′ of an area smaller than the area of the image circle IS as shown in FIGS. 11A through 11C is attached to the image sensing apparatus 1. In this case, it is highly likely that “vignetting” may appear in a large region of a captured image because a distance between the center of the imaging plane of the image sensor 15 and the optical axis of the photographing optical system 46 is larger than a predetermined value. In the case as shown in FIG. 11D, the warning section 70 also causes the liquid crystal display plate 43 to display a warning message such as “shift photographing mode is released in the likelihood of appearance of vignetting” on the display screen of the optical viewfinder 9, for instance.

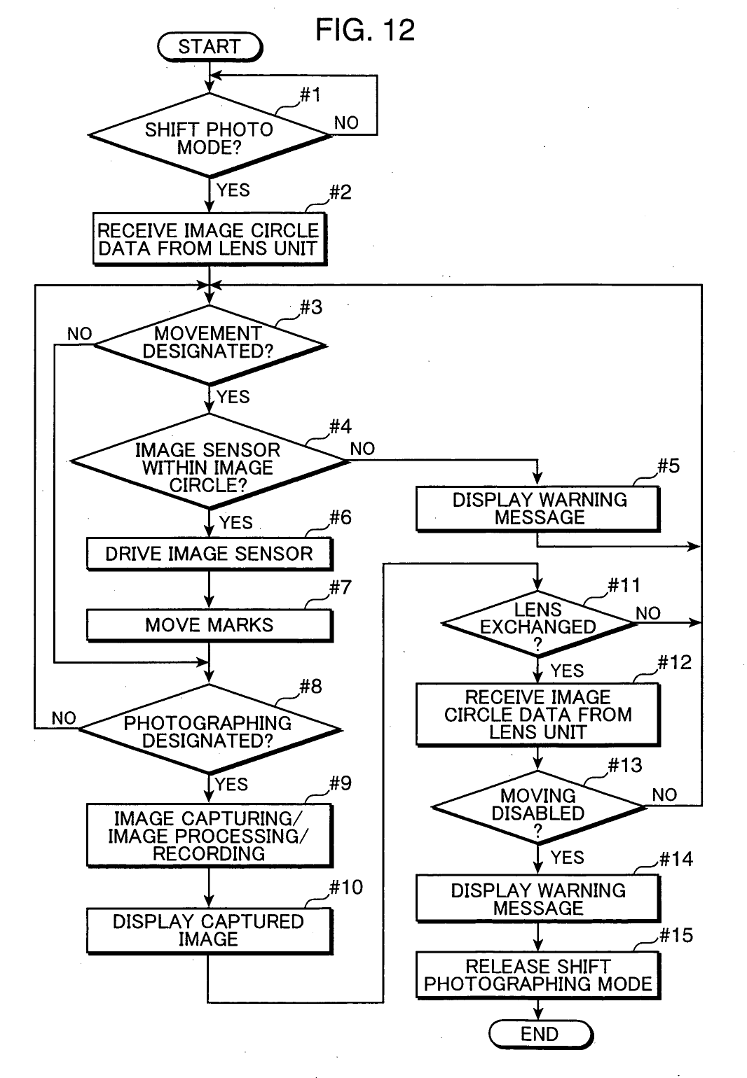

Now, a processing in the shift photographing mode by the image sensing apparatus 1 embodying the invention is described referring to a flowchart shown in FIG. 12. Description is made on a premise that before implementing the processing in the shift photographing mode as shown in the flowchart of FIG. 12, the image sensing apparatus 1 is set to the photographing mode, wherein the center of the imaging plane of the image sensor 15 is aligned with the optical axis of the photographing optical system 46.

As shown in FIG. 12, when the photographer sets the shift photographing mode by operating the shift photographing mode button 6a (YES in Step #1), the main controller 19 receives image circle data of the lens unit 2 from the lens controlling section 50 in the lens unit 2 (Step #2).

Then, in response to designation on movement of the image sensor 15 through manipulation of the jog dial 7 (YES in Step #3), the main controller 19 judges whether the image sensor 15 is moved within the allowable moving range of the image sensor 15, namely, the imaging plane of the image sensor 15 lies within the image circle (Step #4). If it is judged that the image sensor 15 is about to be moved beyond the allowable moving range (NO in Step #4), the main controller 19 is operated to display a warning message as shown in FIG. 9 (Step #5), and the routine returns to Step #3.

On the other hand, if it is judged that the image sensor 15 is moved within the allowable moving range (YES in Step #4), the main controller 19 moves the image sensor 15 in a direction corresponding to the operated pressing portion 7a of the jog dial 7 by a distance corresponding to the number of times of pressing the pressing portion 7a (Step #6) to display the marks 76 and to move the display positions of the marks 76 in a certain direction by a certain moving distance depending on the moving status of the image sensor 15 (Step #7). If it is judged that there is no designation on movement of the image sensor 15 (NO in Step #3), the routine skips Steps S4 through S7, and proceeds to Step #8.

Subsequently, the main controller 19 judges whether the shutter button 4 is brought to a fully pressed state, namely, a photographing operation is instructed (Step #8). If it is judged that the shutter button 4 has not been brought to a fully pressed state, namely, a photographing operation has not been instructed (NO in Step #8), the routine returns to Step #3. On the other hand, if it is judged that the shutter button 4 has been brought to a fully pressed state, namely, a photographing operation has been instructed (YES in Step #8), the main controller 19 causes the image sensor 15 to perform an image capturing operation, performs various image processing with respect to the image captured by the image capturing operation, and records the captured image into the image storage 63 (Step #9). Then, the main controller 19 is operated to display the image recorded in the image storage 63 on the LCD 5 within a certain time after generation of the image (Step #10). Thereby, the photographer can readily confirm whether an intended image has been obtained. If an intended image is not obtained, the photographer can get started a photographing operation again.

Thereafter, until the lens unit 2 is exchanged (NO in Step #11), the main controller 19 cyclically repeats the processing from Step #3 to #11. If the lens unit 2 is exchanged with another one (YES in Step #11), the main controller 19 receives the image circle data of the newly attached lens unit 2 from the lens controlling section 50 in the newly attached lens unit 2 in a similar manner as the processing in Step S2 has been implemented (Step #12).

Subsequently, the main controller 19 judges whether driving of the image sensor 15 is disabled, namely, if the current position of the image sensor 15 is out of the position corresponding to the allowable moving range of the image sensor 15 calculated based on the received image circle data, in other words, judges whether the positional relation between the imaging plane of the image sensor 15 and the image circle is as shown in the illustration of FIG. 11D, for instance (Step #13).

If it is judged that driving of the image sensor 15 is enabled (NO in Step #13), the main controller 19 returns to Step #3. On the other hand, if it is judged that driving of the image sensor 15 is disabled (YES in Step #13), a warning message such as “shift photographing mode is released in the likelihood of appearance of vignetting” is displayed (Step #14), and the shift photographing mode is released (Step #15).

As mentioned above, in the single lens reflex image sensing apparatus 1 constructed such that the lens unit 2 equipped with the built-in photographing optical system 46 is detachably attached to the main body 1A, the image sensor 15 is moved on the plane perpendicular to the optical axis of the photographing optical system 46 in association with an operated state of the jog dial 7 when the shift photographing mode is set. This arrangement enables the photographer to perform shift photographing without the need of a dedicated lens unit for shift photographing, irrespective of the arrangement of the photographing optical system 46 to be loaded. Thereby, the versatility of the image sensing apparatus 1, particularly, of the main body 1A can be improved.

Further, since the photographer can designate movement of the image sensor 15 through manipulation of the jog dial 7, the photographer can locate the image sensor 15 to an intended position to thereby obtain an intended image.

Further, the moving state of the image sensor 15 is displayed on the display screen 71 of the optical viewfinder 9 along with the subject image in terms of the marks 76. Accordingly, the photographer can readily and easily confirm the image capturing area of the image sensor 15 while viewing the subject image through the optical viewfinder 9, thereby ensuring an improved operability of the image sensing apparatus 1. Particularly, in the embodiment, since the inventive image sensing apparatus is of a single lens reflex type, and the subject image is not displayed on the LCD 5 during a photographing preparatory period, the photographer has to confirm the subject image only through the optical viewfinder 9. Therefore, the arrangement that the moving state of the image sensor 15 is displayed on the display screen 71 of the optical viewfinder 9 along with the subject image is advantageous.

Furthermore, when the lens unit 2 is attached to the main body 1A, the allowable moving range of the image sensor 15 is calculated based on the image circle data of the photographing optical system 46 loaded in the lens unit 2. If the moving distance of the image sensor 15 has reached the allowable moving range, or the position of the image sensor 15 at the time of attaching the lens unit 2 is out of the image circle, a warning message such as “vignetting may appear” is displayed, further outward movement of the image sensor 15 is restrained, and the setting of the shift photographing mode is released. This arrangement is effective in preventing appearance of vignetting resulting from movement of the image sensor 15, and consequently, preventing failure in photographing.

Further, in the embodiment, immediately after photographing in the shift photographing mode is performed, namely, immediately after an image for recording is generated, the generated image is displayed on the LCD 5. This arrangement allows the photographer to readily confirm whether an intended image has been obtained. If an intended image is not obtained, the photographer can get started a photographing operation again.

The following modifications through are applicable in addition to or in place of the foregoing embodiment.

The image sensing apparatus 1 may have an anti-shake function of correcting misalignment of the optical axis L by moving or oscillating an optical system for anti-shake or the image sensor 15 according to needs to cancel shake of the apparatus in the case where the misalignment of the optical axis L occurs due to application of an external force to the apparatus by a user such as shake of the apparatus. The anti-shake function is equipped to perform a photographing operation without the likelihood of “image blur” resulting from shake of the apparatus in photographing with one hand, telephotographing, or photographing in a dark place where a long-time exposure is necessary. In such a case, it is preferable to utilize the driving mechanism of the image sensor 15 such as the support/drive mechanism or the actuator of the image sensor 15 as shown in FIGS. 4A through 6 in photographing in the shift photographing mode.

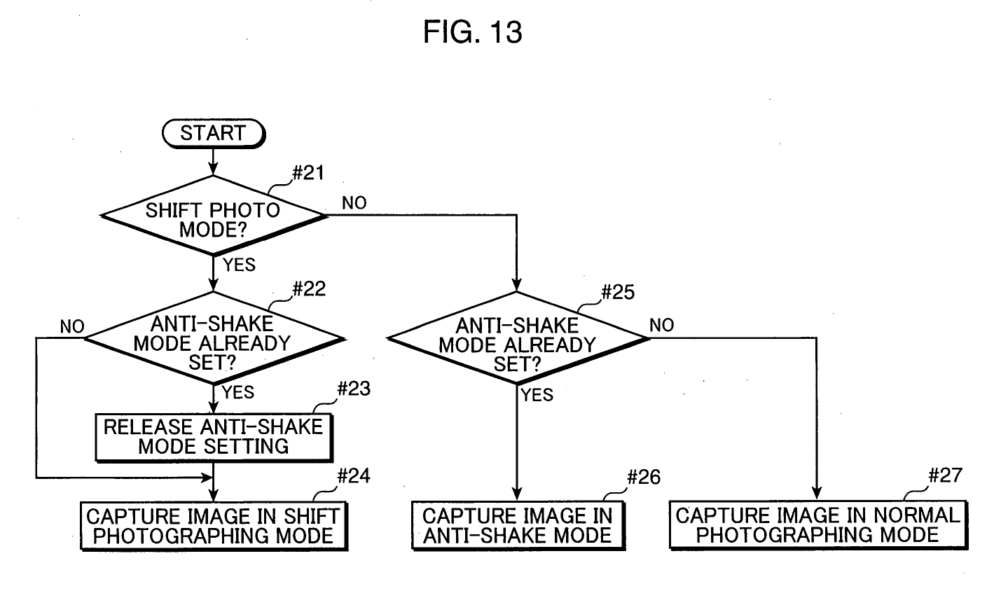

In the case where the driving mechanism of the image sensor 15 is utilized both for the anti-shake function (hereinafter, the mode of implementing this function is called as “anti-shake mode”), and for the shift photographing function (hereinafter, the mode of implementing this function is called as “shift photographing mode”), designing the image sensing apparatus 1 in such a manner that the shift photographing mode and the anti-shake mode are selectively settable as mentioned in the following section enables to simplify the function of the image sensing apparatus 1 to thereby improve the operability of the image sensing apparatus 1. FIG. 13 is a flowchart showing a processing of this operation.

As shown in FIG. 13, if the shift photographing mode is set by operation of the shift photographing mode button 6a (YES in Step #21), the main controller 19 judges whether the anti-shake mode has already been set (Step #22).

If it is judged that the anti-shake mode has already been set (YES in Step #22), the main controller 19 releases the setting of the anti-shake mode (Step #23), and photographing in the shift photographing mode is allowed (Step #24). On the other hand, if it is judged that the anti-shake mode has not been set (NO in Step #22), the routine skips Step #23, and proceeds to Step #24.

If it is judged that the shift photographing mode is not set (NO in Step #21), the main controller 19 judges whether the anti-shake mode has already been set (Step #25).

If it is judged that the anti-shake mode has already been set (YES in Step #25), the main controller 19 allows photographing in the anti-shake mode (Step #26). On the other hand, if it is judged that the anti-shake mode has not been set (NO in Step #25), the main controller 19 allows photographing in a normal photographing mode where the anti-shake correction is not executed (Step #27).

The above processing is implemented in the case where the shift photographing mode and the anti-shake mode are selectively settable, and the shift photographing mode is prioritized over the anti-shake mode. Alternatively, it is possible to prioritize the anti-shake mode over the shift photographing mode.

In the case where the shift photographing mode and the anti-shake mode are simultaneously selectable, the degree of oscillation for anti-shake correction may be reduced if the anti-shake mode is executed while the image sensor is moved. As a result, a possible moving range of the image sensor for anti-shake correction may be narrowed. Selectively designating the shift photographing mode and the anti-shake mode can eliminate such a drawback. Alternatively, it is possible to simultaneously or concurrently execute the shift photographing function and the anti-shake function.

As mentioned above, if the image sensing apparatus 1 is loaded with the function of performing anti-shake correction by driving the image sensor 15 in the above mentioned manner, the function can be used in the shift photographing mode. Such an altered arrangement enables to keep the production cost from unduly rising, which may arise from loading of the shift photographing mode in the image sensing apparatus 1.

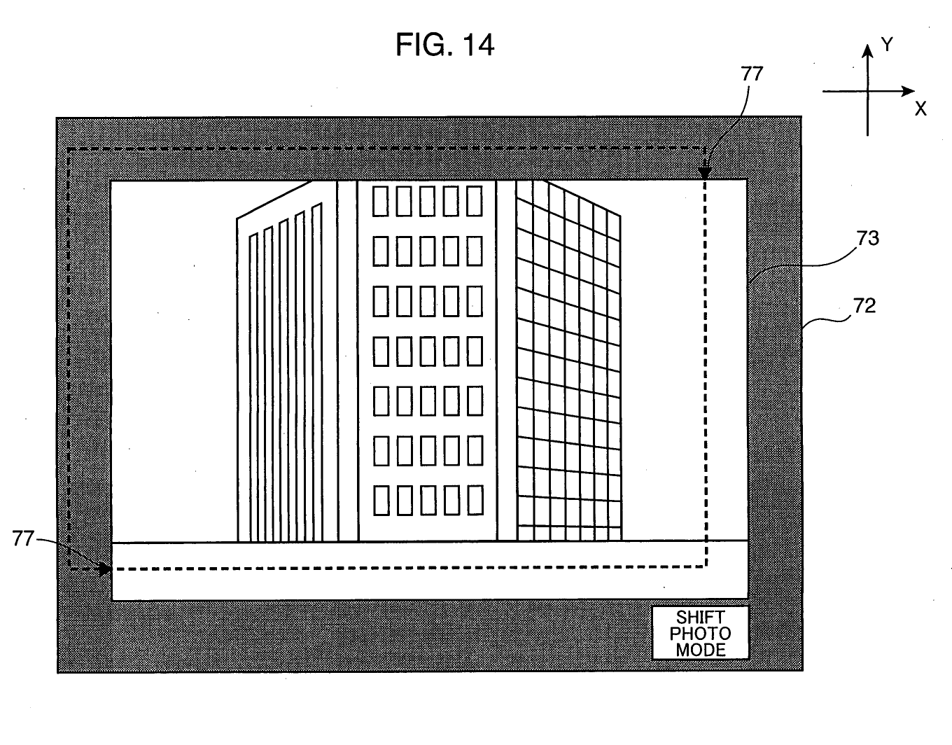

In the foregoing embodiment, an optical image of a subject is displayable on the area 74 between the outer frame 72 and the inner frame 73 on the display screen of the optical viewfinder 9. There is proposed an altered arrangement in which a subject image is not displayed on the area 74 between the outer frame 72 and the inner frame 73. Specifically, as shown in FIG. 14, the image capturing area of the image sensor 15 may be displayed in such a manner that ends of the image capturing area of the image sensor 15 in the X-axis direction and in the Y-axis direction are represented by arrows 77 or like marks on the inner frame 73 with respect to the image capturing area of the image sensor 15 that has been moved by shift photographing, as shown by the dotted lines, if the display area or the angle of view of the optical viewfinder 9 is identical to the image capturing area of the image sensor 15.

In the foregoing embodiment, if the moving distance of the image sensor 15 has reached the allowable moving range of the image sensor 15, or the position of the image sensor 15 at the time of attaching the lens unit 2 is out of the image circle, a warning message alerting the user of appearance of vignetting is displayed, and further movement of the image sensor 15 over the allowable moving range is restrained. Alternatively, either one of the warning message display and the movement restraint may be performed. In the case where the warning message is displayed without movement restraint of the image sensor 15, the photographer is allowed to make judgment as to whether to continue moving the image sensor 15, thereby allowing the photographer to obtain an intended image.

In the foregoing embodiment, described is the single lens reflex image sensing apparatus constructed such that rays of light are not introduced to the image sensor 15 during a photographing preparatory period, and accordingly, the photographer cannot confirm a subject image actually captured by the image sensor 15 on the LCD 5. Alternatively, it is possible to display the image capturing area of the image sensor 15 which has been moved by driving of the image sensor 15 in an arrangement that rays of light are introduced onto the image sensor 15 and onto the optical viewfinder 9 during a photographing preparatory period, so that the photographer can confirm a subject image actually captured by the image sensor 15 on the LCD 5. Such an altered arrangement is advantageous because the photographer can securely confirm the focal state on the display screen 71 of the optical viewfinder 9 rather than confirmation on the display screen of the LCD 5.

The invention is not only applicable to the image sensing apparatus of a single lens reflex type but also applicable to a so-called compact camera.

Specifically, in a compact camera equipped with an optical viewfinder and an LCD, a subject image can be displayed on the LCD as well as on the optical viewfinder during a photographing preparatory period until generation of an image for recording is designated. Displaying the moving state of the image sensor 15 on the LCD enables to obtain a similar effect as in the arrangement of displaying the moving state of the image sensor 15 on the display screen of the optical viewfinder 9.

As described above, an image sensing apparatus is provided with an image sensor having an imaging plane for photoelectrically converting received light into an electrical signal; a photographing optical system having an image circle larger than an area of the imaging plane of the image sensor, the photographing optical system being adapted to form an optical image of a subject onto the imaging plane of the image sensor; a driving section for driving the image sensor over a plane perpendicular to an optical axis of the photographing optical system; and a controller for controlling the driving section to perform a shift photographing mode of executing photographing in a state that the center of the imaging plane of the image sensor is shifted from the optical axis of the photographing optical system.

In this arrangement, the image sensor is movable on the image formable plane larger than the imaging plane of the image sensor, and the image sensing apparatus has the shift photographing mode for allowing the user to perform shift photographing in a state that the center of the imaging plane of the image sensor is shifted from the optical axis of the photographing optical system. This arrangement enables the user to perform shift photographing irrespective of the arrangement of the photographing optical system to be loaded without the need of purchasing a shift lens, which has been required in the conventional arrangement.

Since the user can perform shift photographing irrespective of the arrangement of the photographing optical system to be loaded, the operability of the image sensing apparatus concerning the shift photographing can be improved.

The image sensing apparatus may be further provided with an input operating section through which designation on driving of the image sensor is inputted to the driving section. In this case, the controller controls the driving section to move the image sensor in accordance with designation contents in response to the input of the designation by the input operating section.

In this arrangement, since the user can designate movement of the image sensor by way of the input operating section, the user can acquire an intended image. Accordingly, the operability of the image sensing apparatus concerning movement of the image sensor can be improved.

The controller may be preferably made to control the driving section to perform an anti-shake mode of driving the image sensor on the plane perpendicular to the optical axis of the photographing optical system to correct blurring of the subject optical image formed on the image sensor due to shake of the apparatus.

In this arrangement, the user can utilize the anti-shake function of the image sensing apparatus in loading the shift photographing mode in the image sensing apparatus. This arrangement keeps the production cost of the image sensing apparatus from unduly rising. This arrangement enables to keep the production cost of the image sensing apparatus from unduly rising, and to avoid increase in the size of the image sensing apparatus even if the shift photographing mode is loaded in the image sensing apparatus.

The shift photographing mode and the anti-shake mode may be preferably made to be selectively operable.

In this arrangement, since the shift photographing mode and the anti-shake mode are selectively operable, as compared with an image sensing apparatus capable of executing the shift photographing mode and the anti-shake mode simultaneously, the function of the image sensing apparatus can be simplified. If the shift photographing mode and the anti-shake mode are simultaneously selectable, the degree of oscillation for anti-shake correction may be reduced if the anti-shake mode is executed while the image sensor is moved. As a result, a possible moving range of the image sensor for anti-shake correction may be narrowed. Selectively designating the shift photographing mode and the anti-shake mode can eliminate such a drawback.

As compared with the image sensing apparatus capable of executing the shift photographing mode and the anti-shake mode simultaneously, the function of the image sensing apparatus is simplified. This arrangement contributes to an improved operability of the image sensing apparatus.

The image sensing apparatus may be further provided with a display section for displaying information relating to a moving state of the image sensor, and a first display controlling section for controlling the display section to display information relating to the moving state of the image sensor.

In this arrangement, since the information relating to the moving state of the image sensor is displayed on the display section, the user can visually recognize the moving state of the image sensor.

The display section may be preferably provided with an optical viewfinder for allowing the user to optically observe the subject optical image introduced from the photographing optical system. In this case, the first display controlling section controls the display section to display information relating to the moving state of the image sensor on a display screen of the optical viewfinder.

In the arrangement of the image sensing apparatus having the optical viewfinder for allowing the user to optically observe the optical subject image introduced from the photographing optical system, the user can visually recognize the moving state of the image sensor on the display screen of the optical viewfinder. This arrangement is particularly advantageous in an image sensing apparatus constructed such that an optical viewfinder is the only device for allowing the user to visually recognize a subject optical image.

The display screen may preferably have a display area larger than an image capturing area of the image sensor. In this case, the first display controlling section controls the display section to display information relating to the moving state of the image sensor on the display area of the display screen other than an area corresponding to the image capturing area.

In the arrangement where the display screen has the display area larger than the image capturing area of the image sensor, and the information relating to the moving state of the image sensor is displayed on the area on the display screen other than the area corresponding to the image capturing area, the user can readily recognize both the optical subject image captured by the image sensor and the moving state of the image sensor.

The image sensing apparatus may be further provided with an image display section for displaying an image using an image signal acquired by an image capturing operation of the image sensor, and a second display controlling section for controlling the image display section to display a captured image constituted of pixel signals for recording within a certain time from the point of time when the pixel signals have been generated in response to the generation of the pixel signals.

In this arrangement, when the image sensing apparatus is set in the shift photographing mode, the captured image constituted of the pixel signals for recording is displayed on the image display section within the certain time from the point of time when the pixel signals have been generated. This arrangement enables the user to readily confirm whether an intended image has been captured. If it is judged that the intended image has not been captured, the user can promptly get started photographing again.

The second display controlling section may be preferably control the image display section to display information relating to the moving state of the image sensor on a display screen of the image display section.

In this arrangement, the user can visually recognize the moving state of the image sensor on the display screen of the image display section.

According to these arrangements, further, the operability of the image sensing apparatus concerning movement of the image sensor can be improved.

The image sensing apparatus may be further provided with a main body having a communicating section; and a lens unit which has a communicating section and is detachably attachable to the main body, the lens unit being communicable with the main body via their respective communicating sections.

The main body may preferably include a warning section for alerting the user of the likelihood of appearance of vignetting in light of a relation between the size of the image circle of the lens unit, and a moving distance of the image sensor upon receiving data relating to the image circle of the lens unit in response to attachment of the lens unit.

In this arrangement, since the alerting section alerts the user of the likelihood of appearance of vignetting in light of the relation between the size of the image circle of the lens unit attached to the main body, and the moving distance of the image sensor, the user is allowed to judge whether to continue moving the image sensor. This arrangement enables the user to acquire an intended image.

Also, the main body may preferably include a restricting section for restricting a moving distance of the image sensor based on data relating to the image circle of the lens unit upon receiving the data in response to attachment of the lens unit.

In this arrangement, since the moving distance of the image sensor is limited based on the size of the image circle of the lens unit attached to the main body, this arrangement obviates the occurrence of vignetting resulting from movement of the image sensor.

According to these arrangements, failure in photographing, which may arise from movement of the image sensor, can be obviated.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image sensing apparatus comprising:
an image sensor which photoelectrically converts received light into an electrical signal, the image sensor including an imaging plane;
a photographing optical system having an image circle larger than an area of the imaging plane of the image sensor, the photographing optical system being adapted to form an optical image of a subject onto the imaging plane of the image sensor;
a driving section which drives the image sensor over a plane perpendicular to an optical axis of the photographing optical system; and
a controller which controls the driving section to perform a shift photographing mode of executing photographing in a state that the center of the imaging plane of the image sensor is shifted from the optical axis of the photographing optical system.

2. The image sensing apparatus according to claim 1, further comprising an input operating section through which designation on driving of the image sensor is inputted to the driving section, wherein the controller controls the driving section to move the image sensor in accordance with designation contents in response to the input of the designation by the input operating section.

3. The image sensing apparatus according to claim 1, wherein the controller controls the driving section to perform an anti-shake mode of driving the image sensor on the plane perpendicular to the optical axis of the photographing optical system to correct blurring of the subject optical image formed on the image sensor due to shake of the apparatus.

4. The image sensing apparatus according to claim 3, wherein the shift photographing mode and the anti-shake mode are selectively operable.

5. The image sensing apparatus according to claim 1, further comprising a display section which displays information relating to a moving state of the image sensor, and a first display controlling section which controls the display section to display information relating to the moving state of the image sensor.

6. The image sensing apparatus according to claim 5, wherein the display section includes an optical viewfinder for allowing the user to optically observe the subject optical image introduced from the photographing optical system, and the first display controlling section controls the display section to display information relating to the moving state of the image sensor on a display screen of the optical viewfinder.

7. The image sensing apparatus according to claim 6, wherein the display screen has a display area larger than an image capturing area of the image sensor, and the first display controlling section controls the display section to display information relating to the moving state of the image sensor on the display area of the display screen other than an area corresponding to the image capturing area.

8. The image sensing apparatus according to claim 1, further comprising an image display section which displays an image using an image signal acquired by an image capturing operation of the image sensor, and a second display controlling section which controls the image display section to display a captured image constituted of pixel signals for recording within a certain time from the point of time when the pixel signals have been generated in response to the generation of the pixel signals.

9. The image sensing apparatus according to claim 8, wherein the second display controlling section controls the image display section to display information relating to the moving state of the image sensor on a display screen of the image display section.

10. The image sensing apparatus according to claim 1, further comprising:
a main body having a communicating section; and
a lens unit which has a communicating section and is detachably attachable to the main body, the lens unit being communicable with the main body via their respective communicating sections;
wherein the main body includes a warning section which alerts the user of the likelihood of appearance of vignetting in light of a relation between the size of the image circle of the lens unit, and a moving distance of the image sensor upon receiving data relating to the image circle of the lens unit in response to attachment of the lens unit.

11. The image sensing apparatus according to claim 1, further comprising:
a main body having a communicating section; and
a lens unit which has a communicating section and is detachably attachable to the main body, the lens unit being communicable with the main body via their respective communicating sections;
wherein the main body includes a restricting section which restricts a moving distance of the image sensor based on data relating to the image circle of the lens unit upon receiving the data in response to attachment of the lens unit.
